(19) United States
(12) Patent Application Publication
(10) Pub. No.: US 2014/0356890 A1
(43) Pub. Date: Dec. 4, 2014

(54) METHOD OF RE-COLLECTING TARGET MATERIAL

(71) Applicant: Samsung Electronics Co., Ltd., Suwon-si (KR)

(72) Inventors: June-young LEE, Anyang-si (KR); Hui-sung MOON, Seoul (KR); Jin-ho OH, Seoul (KR); Yeon-jeong KIM, Yongin-si (KR); Kyung-yeon HAN, Seoul (KR)

(73) Assignee: Samsung Electronics Co., Ltd., Suwon-si (KR)

(21) Appl. No.: 14/080,632

(22) Filed: Nov. 14, 2013

(30) Foreign Application Priority Data
Jun. 3, 2013 (KR) 10-2013-0063704

(51) Int. Cl. G01N 1/34

(52) U.S. Cl. CPC G01N 1/34
USPC 435/29

(57) ABSTRACT

A method of re-collecting a target material using a filter is provided. The method includes reversely flowing a first fluid from a first flow channel towards a second flow channel through a filter unit so that the target material is included in the first fluid that flows through the second flow channel, wherein the filter includes: the first flow channel, the second flow channel that at least in part overlaps the first flow channel and is disposed above the first flow channel, and the filter unit that is disposed on a region where the first flow channel overlaps the second flow channel and where the target material is captured.

### CROSS-REFERENCE TO RELATED APPLICATIONS

This application claims the benefit of Korean Patent Application No. 10-2013-0063704, filed on Jun. 3, 2013, in the Korean Intellectual Property Office, the entire disclosure of which is hereby incorporated by reference.

### BACKGROUND

1. Field

The present disclosure relates to methods of re-collecting a target material, and more particularly, to three-dimensional filters and methods of re-collecting a target material from the three-dimensional filters.

2. Description of the Related Art

An early detection of cancer is important to cure it. Accordingly, there has been much research to find methods of rapidly, conveniently, and correctly detecting cancer. Recently, a method of diagnosing cancer by capturing circulating tumor cells (CTCs) in blood has been proposed. However, it is very difficult to capture the CTCs from blood as the number of CTCs in the blood can be very low. For example, in the case of breast cancer, approximately less than 5 CTCs may be detected in a 7.5 ml blood sample, and in the case of colorectal cancer, approximately less than 3 CTCs may be detected in a 7.5 ml blood sample. Accordingly, for a correct cancer diagnosis, it is important to capture the rare CTCs without loss. Also, the capturing must be performed in an atmosphere in which the CTCs are minimally adversely affected, as CTCs readily become extinct.

The capturing of CTCs in blood may be achieved by using a filter that filters out only CTCs but allows red blood cells and white blood cells to pass through. The filter generally has a structure in which a plurality of complicated patterns having a column shape are formed in a micro-flow channel through which blood can flow. In this case, the red blood cells and white blood cells, which have a relatively small size, may pass through the patterns, but the CTCs having a relatively large size may be captured between the patterns. However, in a filter having the above structure, the flow channel may be clogged by the captured CTCs. Once clogging of the flow channel occurs, pressure is applied to the CTCs, and the CTCs may be damaged. Also, white blood cells may be captured together with the CTCs, reducing analytical efficiency and increasing analytical time. It is also important to develop a method of safely re-collecting the CTCs because they readily become extinct.

### SUMMARY

Provided are filters for safely capturing a target material in a fluid by allowing the fluid to have a three-dimensional flow. Also provided are methods of re-collecting a target material captured in the filter. Additional aspects will be set forth in the description that follows.

According to an aspect of the present invention, there is provided a method of re-collecting a target material by using a filter, the method including reversely flowing a first fluid from a first flow channel towards a second flow channel through a filter unit so that the target material is included in the first fluid that flows through the second flow channel, wherein the filter includes: the first flow channel; the second flow channel, of which a portion overlaps with the first flow channel, that is disposed above the first flow channel; and a filter unit that is disposed on a region where the first flow channel overlaps the second flow channel and where the target material is captured. The method may further include discharging the first fluid from the second flow channel. The method may further include extracting the target material from the discharged first fluid. Non-target materials may also be captured on the filter unit, and the first fluid carries the target material and not the non-target materials.

The velocity of the reverse flow of the first fluid may vary according to regions of the filter unit when the first fluid flows through the filter unit. The velocity of the reverse flow of the first fluid may be the highest at a region of the filter unit where the first fluid primarily passes through the filter unit.

The target material may be captured at an edge region of the filter unit. The first fluid may flow in the same direction in the first and second flow channels. The first fluid may pass through the filter unit in a direction perpendicular to the flow direction in the first flow channel. The first fluid may include at least one of water and peripheral blood smear (PBS). The target material may be captured on the filter unit when a second fluid flows to the first flow channel after passing through the filter unit.

The filter unit may include at least one opening, and a diameter of the target material may be greater than a width of the opening and may be smaller than a length of the opening. The at least one opening may have a polygonal shape, a circular shape, or an oval shape. The at least one opening may be arranged in a one-dimensional array or a two-dimensional array.

The filter may include a first substrate, a second substrate separated from the first substrate, and a third substrate that contacts an upper surface of the first substrate and a lower surface of the second substrate. The first flow channel may be formed by etching the upper surface of the first substrate. The second flow channel may be formed by etching the lower surface of the second substrate. The filter unit may be formed by etching the third substrate through the third substrate. The filter unit may further include an inlet that contacts the second flow channel through the first substrate, and the first fluid may be discharged through the inlet. The filter may further include an outlet that is connected to the second flow channel through the first and third substrates, and the first fluid may enter into the second flow channel through the outlet. The filter may further include an outlet that is connected to the second flow channel through the second substrate, and the first fluid may enter into the second flow channel through the outlet.

According to an aspect of the present invention, there is provided a method of re-collecting a target material from a filter that includes a filter unit on which the target material is captured on a region thereof, the method including reversely flowing a first fluid through the filter unit so that the target material is included in the first fluid. The velocity of a reverse flow of the first fluid may vary according to regions of the filter unit when the first fluid passes through the filter unit. The filter unit may capture non-target materials and the first fluid may carry the target material and not the non-target materials. The filter unit may include at least one opening, and a diameter of the target material may be greater than a width of the opening and may be smaller than a length of the opening.

### BRIEF DESCRIPTION OF THE DRAWINGS

These and/or other aspects will become apparent and more readily appreciated from the following description of the embodiments taken in conjunction with the accompanying drawings, in which:

FIG. 1 is a schematic perspective view of a filter;

FIG. 2 is an exploded perspective view of surface structures of substrates included in the filter of FIG. 1;

FIGS. 3A through 3E are cross-sectional views showing a method of manufacturing the filter;

FIG. 4 is a cross-sectional view taken along line A-A′ of the filter of FIG. 1 for capturing a target material;

FIG. 5 is an image of a target material captured in a region of a filter unit;

FIG. 6 is a cross-sectional view for explaining a method of capturing a target material captured in the filter of FIG. 1;

FIG. 7A is a photo image of the filter in which a target material and non-target materials are captured;

FIG. 7B is a photo image of the filter from which the target material is re-collected by reverse flowing a fluid;

FIG. 8A is a graph showing a result of measuring a velocity of a fluid in a y-axis direction in a filter unit;

FIG. 8B is a graph showing a result of measuring a velocity of a fluid in an x-axis direction in the filter unit;

FIG. 9 is a graph showing a simulation result of pressure applied by the second fluid to noise according to a distribution range of the noise;

FIG. 10 is a table summarizing measured results of re-collect rates of a captured target material;

FIG. 11 is a table summarizing measured viabilities of a re-collected target material;

FIG. 12 is a cross-sectional view of a filter that includes port flow channels;

FIG. 13 is a schematic perspective view of an alternative embodiment of a filter;

FIG. 14 is a schematic perspective view of another alternative embodiment of a filter; and

FIG. 15 is a cross-sectional view of another alternative embodiment a filter.

### DETAILED DESCRIPTION

Filters for readily capturing and re-collecting or recovering a target material, methods of capturing the target material using the filters, and methods of re-collecting the captured target material, according to embodiments of the present invention, are described in detail with reference to the accompanying drawings. In the drawings, like reference numerals refer to like elements throughout and the thicknesses of layers and regions are exaggerated for clarity.

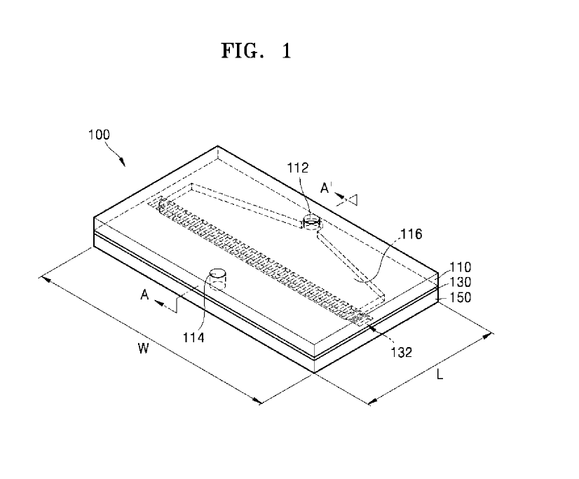

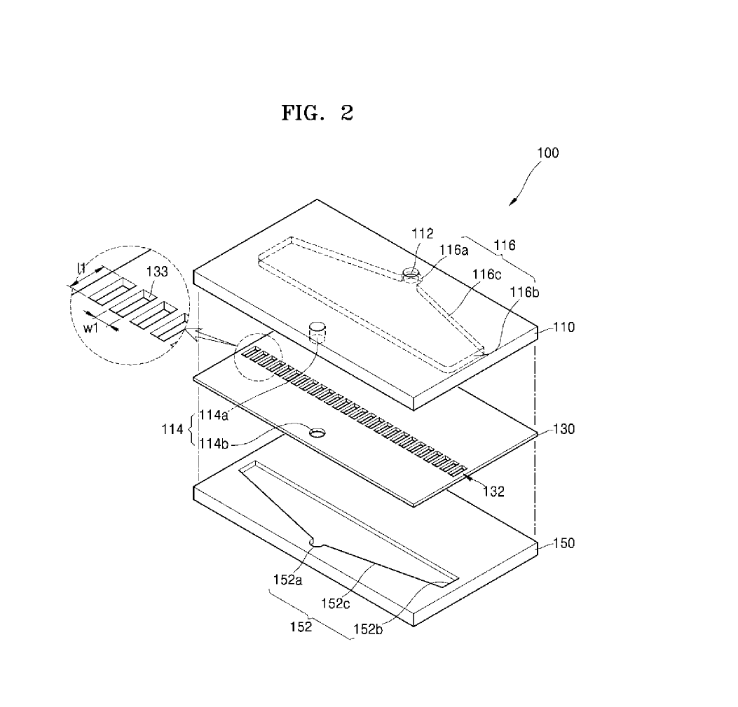

FIG. 1 is a schematic perspective view of a filter 100 according to an embodiment of the present invention. FIG. 2 is an exploded perspective view of surface structures of first through third substrates 110, 130, and 150 included in the filter 100 of FIG. 1.

Referring to FIGS. 1 and 2, the filter 100 according the current embodiment may include an inlet 112 through which a fluid to be investigated enters, an outlet 114 through which the inspected fluid is discharged, a first flow channel 116 that is connected to the inlet 112 and through which the fluid that enters through the inlet 112 flows, a second flow channel 152 that is connected to the outlet 114 and through which the fluid flows towards the outlet 114, and a filter unit 132 that is disposed between the first flow channel 116 and the second flow channel 152 that captures a target material by filtering the fluid that flows through the first flow channel 116 and falls down into the second flow channel 152. The fluid to be inspected denotes a fluid that includes a target material, and is referred to as a first fluid. Also, a fluid from which a captured target material will be re-collected is referred to as a re-collect fluid or a second fluid. Also, the first and second fluids may be referred to as simply a fluid.

A fluid that flows through the filter 100 may have different flow directions when the fluid flows through the first flow channel 116, the filter unit 132, and the second flow channel 152. For example, the flow direction of the fluid that flows through the first flow channel 116 and the flow direction of the fluid that flows through the second flow channel 152 may be generally in the same direction substantially parallel to each other. The flow direction of the fluid that flows through the first flow channel 116 and the flow direction of the fluid that flows through the second flow channel 152 may be parallel to each other by being separated by the thickness of the filter unit 132 disposed between the first flow channel 116 and the second flow channel 152. Also, the flow direction of the fluid that flows through the first flow channel 116 and the flow direction of the fluid that as it passes through the filter unit 132 may be perpendicular to each other. In other words, the flow path through the filter unit 132, which is defined by the thickness of the filter unit 132, is substantially perpendicular to the flow paths defined by the first flow channel 116 and second flow channel 152.

The filter 100 may be formed by combining the first through third substrates 110, 130, and 150 having flat surfaces where the inlet 112, the outlet 114, the first flow channel 116, the second flow channel 152, and the filter unit 132 are formed.

Referring to FIG. 2, the first substrate 110 may include the inlet 112 that is formed through the first substrate 110, the first flow channel 116 that is connected to the inlet 112 and is formed by etching a lower surface of the first substrate 110, and a portion of the outlet 114 (hereinafter, a first outlet 114a) that is disposed separately from the inlet 112 and is formed through the first substrate 110. The first substrate 110 may have a rectangular shape having a width W greater than twice or more of a length L. For example, the first substrate 110 may have a width of approximately 3 cm and a length of approximately 1.5 cm. The first substrate 110 may be formed of transparent glass or plastic. However, the present invention is not limited thereto, and the first substrate 110 may be formed of, for example, acrylate, polymethylacrylate, polymethylmethacrylate (PMMA), polycarbonate, polystyrene, polyimide, epoxy resin, polydimethylsiloxane (PDMS), or parylene.

The second substrate 130 may include the filter unit 132 that captures a target material from the first fluid that flows through the first flow channel 116 and passes a remaining portion of the first fluid. The filter unit 132 may include at least one opening 133 that passes through the second substrate 130, and may include a plurality of openings 133. The second substrate 130 may have a plate shape or a bar shape. A length 11 of the opening 133, that is, the dimension in a direction of the first flow channel 116 or the second flow channel 152, may be greater than a width w1 of the opening 133, that is, the dimension in a direction perpendicular to the direction of the first flow channel 116 or the second flow channel 152. A depth of the opening 133, that is, the dimension corresponding to the thickness of the second substrate 130 allows the target material to pass through. For example, the depth of the opening 133 may be in a range from about 5 μm to about 50 μm. That is, the opening 133 has a rectangular shape in which a dimension in the direction of the first flow channel 116 or the second flow channel 152 is longer than the dimension in a direction perpendicular to the direction of the first flow channel 116 or the second flow channel 152.

The opening 133 may be formed in a polygonal, circle, or oval shape. In FIG. 2, the opening 133 has a quadrangular shape, but the present invention is not limited thereto. A width w1 of the opening 133 is smaller than a diameter of the target material and may allow materials other than the target material to pass. Thus, the target material may not pass through the opening 133 and may accumulate on the filter unit 132. Also, the opening 133 may have a length l1 greater than the diameter of the target material. Since the length l1 of the opening 133 is greater than the diameter of the target material, the clogging of the filter unit 132 by the target material may be avoided. For example, the opening 133 may have a width w1 in a range from about a few μm to about a few hundred μm, and have a length l1 in a range from about a few tens of μm to about a few mm.

When the filter unit 132 comprises a plurality of openings 133, the openings 133 of the filter unit 132 may be arranged as a one-dimensional array or a two-dimensional array. The one-dimensional array may be one in which the openings 133, having a long side in a direction of flow through the first flow channel 116 or the second flow channel 152, are arranged in parallel in a row. The row of openings may be arranged in a direction perpendicular to the flow path of the first or second flow channels 116 and 152. The two-dimensional array may be one in which the openings 133 having a long side in a direction of flow through the first flow channel 116 or the second flow channel 152 are arranged in two or more parallel rows. For instance, the individual openings 133 may have a long side in the direction of flow through the first and second flow channels 116 and 152, and a short side in the direction perpendicular to the direction of flow through the first and second channels 116 and 152. A first row of the openings 133 may be arranged in a direction perpendicular to the direction of flow through the first and second channels 116 and 152, and a second row (and, optionally, subsequent rows) may be arranged adjacent and parallel to the first row, forming a two-dimensional array of openings 133.

The second substrate 130 may include a remaining portion of the outlet 114 (hereinafter, a second outlet 114b) that is separately disposed from the filter unit 132 and is formed through the second substrate 130. The second substrate 130 may have the same width W and length L as the first substrate 110. However, the present invention is not limited thereto, and the second substrate 130 may have a different width or length than the first substrate 110. The second substrate 130 may be formed of, for example, glass, quartz, transparent plastic, polymer, silicon, polysiloxane, polyurethane, polysilicon-polyurethane, rubber, ethylene-vinyl acetate copolymer, phenolic nitrile rubber, styrene butadiene rubber, polyether-block-amide, or polyolefin.

The third substrate 150 may include the second flow channel 152 formed by etching an upper surface of the third substrate 150. An edge of the second flow channel 152 may be connected to the filter unit 132, and the other edge of the second flow channel 152 may be connected to the second outlet 114b. Also, the third substrate 150 may have the same width W and length L as the first substrate 110. However, the present invention is not limited thereto, and the third substrate 150 may have a different width or length than the first substrate 110. The third substrate 150 may be formed of, for example, transparent glass, quartz, plastic, or polymer to observe captured cells or particles.

The first flow channel 116 may include a first part 116a that is a region connected to the inlet 112, a second part 116b that is a region connected to the filter unit 132, and a first central part 116c that is a region between the first part 116a and the second part 116b. As depicted in FIG. 2, the first part 116a and the second part 116b have shapes respectively corresponding to the inlet 112 and the filter unit 132. The first central part 116c may be formed in a tapered shape. For example, the first central part 116c may gradually widen from the first part 116a towards the second part 116b. The first central part 116c may be formed with a width greater than its length. A ratio of the width to the length may be 3:1 or more and may be less than 100:1. In this configuration, an excessive increase in the velocity of the fluid may be prevented, and a pressure applied to the filter unit 132 may be reduced.

The second flow channel 152 may include a third part 152a that is a region connected to the outlet 114, a fourth part 152b that is a region connected to the filter unit 132, and a second central part 152c that is a region between the third part 152a and the fourth part 152b. As depicted in FIG. 2, the third part 152a and the fourth part 152b have shapes respectively corresponding to the outlet 114 and the filter unit 132. The second central part 152c may have a tapered shape. For example, the second central part 152c may gradually narrow from the third part 152a towards the fourth part 152b so that fluid is readily discharged through the outlet 114.

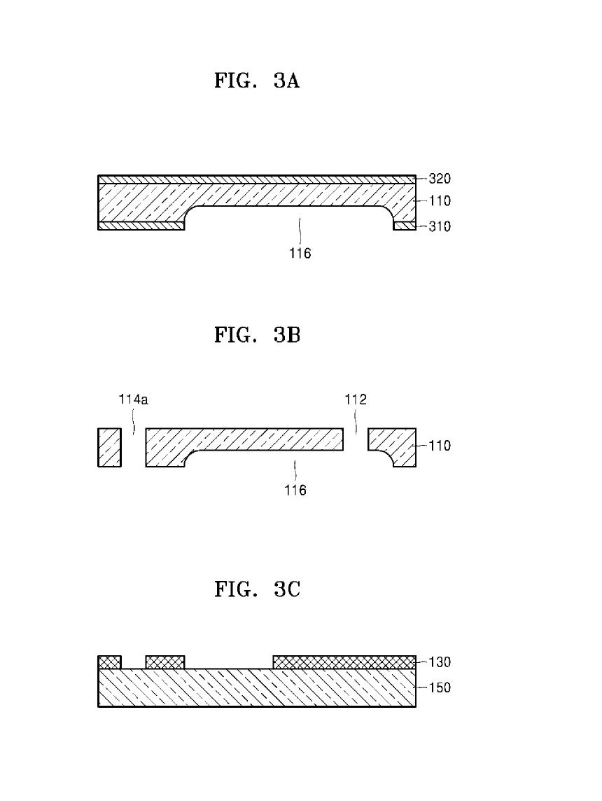

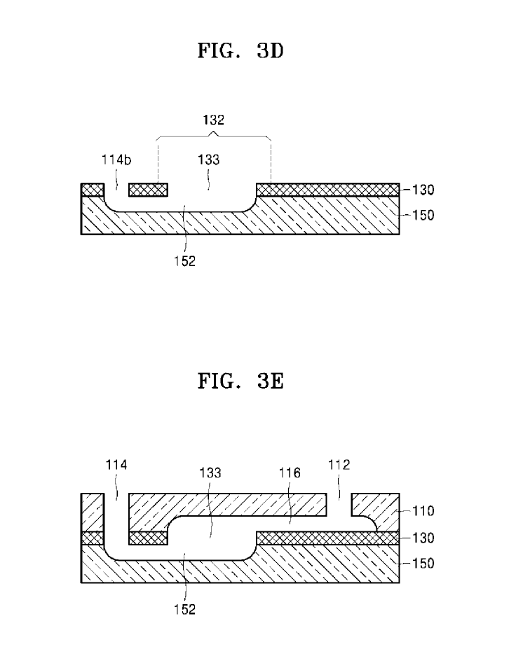

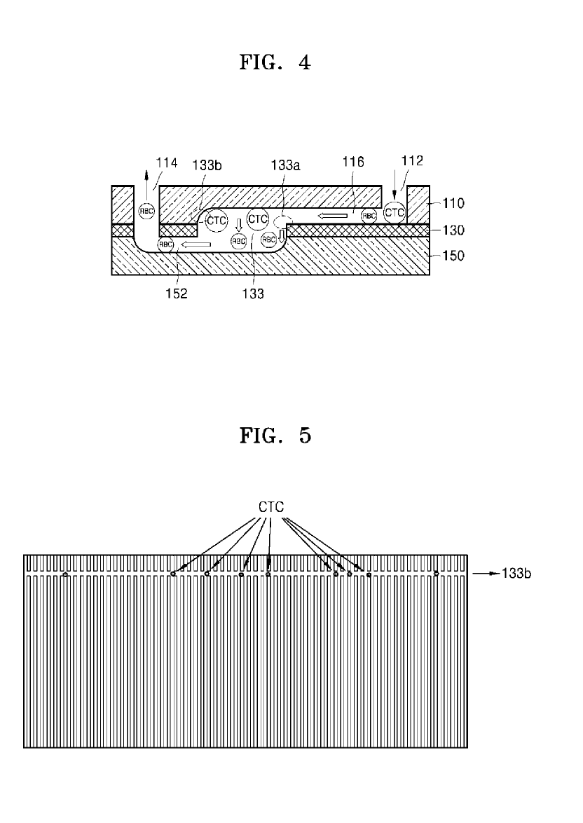

A method of manufacturing the filter 100 is described with reference to FIGS. 3A through 3E. Referring to FIG. 3A, etch mask layers 310 and 320 are formed on upper and lower surfaces of the first substrate 110, respectively. The first substrate 110 may be formed of transparent glass or transparent plastic. However, the present invention is not limited thereto, and the first substrate 110 may be formed of, for example, acrylate, polymethylacrylate, PMMA, polycarbonate, polystyrene, polyimide, epoxy resin, PDMS, or parylene. The etch mask layers 310 and 320 are patterned using a photolithography process. Afterwards, the first flow channel 116 is formed by wet etching the first substrate 110 using an hydrofluoric acid (HF) solution. When the first flow channel 116 is formed, a region of the first flow channel 116 where a flow direction of fluid changes may be formed as a curved surface to prevent damage to the target material. For instance, the end of the first flow channel formed in the first substrate furthest from the inlet may have a curved surface.

Next, after removing the etch mask layers 310 and 320 from the first substrate 110, as depicted in FIG. 3B, the inlet 112 and the first outlet 114a that pass through the first substrate 110 are formed. The inlet 112 and the first outlet 114a may be formed by using a sand blast process. The inlet 112 and the first outlet 114a may be formed separately from each other. Also, the inlet 112 may be formed to connect with the first flow channel 116, and the first outlet 114a may be formed not to connect with the first flow channel 116.

Next, referring to FIG. 3C, the second substrate 130 is formed on the third substrate 150. The second substrate 130 may be formed of, for example, silicon, polysiloxane, polyurethane, polysilicon-polyurethane, rubber, ethylene-vinyl acetate copolymer, phenolic nitrile rubber, styrene butadiene rubber, polyether-block-amide, or polyolefin. The third substrate 150 may be formed of, for example, acrylate, polymethylacrylate, PMMA polycarbonate, polystyrene, polyimide, epoxy resin, PDMS, or parylene. The second substrate 130 and the third substrate 150 may be a single silicon-on-glass (SOG) wafer.

As depicted in FIG. 3D, the second outlet 114b and the filter unit 132 that pass through the second substrate 130 may be formed. For example, the second substrate 130 may be an SOG wafer patterned using a photolithography process. Next, the second outlet 114b and the filter unit 132 may be formed in a silicon layer by using a deep reactive ion etching (DRIE) process. The filter unit 132 may include at least one opening 133. A width W of the opening 133 (shown in FIG. 2) may be smaller than a diameter of the target material so that the target material is unable to pass through the opening 133. However, a length L of the opening 133 (shown in FIG. 2) may be greater than the diameter of the target material. For example, the at least one opening 133 may be arranged in a one-dimensional array. However, the present invention is not limited thereto, and the at least one opening 133 may be arranged in a two-dimensional array. The second outlet 114b may be disposed separately from the at least one opening 133.

Also as depicted in FIG. 3D, the second flow channel 152 is formed by etching a portion of the third substrate 150. The second flow channel 152 may be formed such that an edge thereof is connected to the filter unit 132 and the other edge thereof is connected to the second outlet 114b. For example, the third substrate 150 may be an SOG wafer in which the first outlet 114a and the filter unit 132 are formed, and may be wet etched by using an HF solution.

Afterwards, as depicted in FIG. 3E, the first substrate 110, in which the inlet 112, the first flow channel 116, and the first outlet 114a are formed, is combined with the second substrate 130, in which the second outlet 114b and the at least one opening 133 are formed. The first substrate 110 and the second substrate 130 may be combined by using an anodic bonding process. As described above, the filter 100 may be readily formed by using an etching process.

Next, a method of capturing the target material using the filter 100 and a method of re-collecting the captured target material will be described.

FIG. 4 is a cross-sectional view taken along line A-A′ of the filter 100 of FIG. 1. As depicted in FIG. 4, when a fluid to be inspected, that is, the first fluid, enters through the inlet 112 of the filter 100, the first fluid flows towards the outlet 114 along the first flow channel 116, the filter unit 132, and the second flow channel 152. The first fluid may be blood. A depth of the first flow channel 116, that is, a gap between a surface formed by etching the lower surface of the first substrate 110 and the upper surface of the second substrate 130 may have a size through which the first fluid readily flows. For example, the first flow channel 116 may have a depth of approximately 50 μm. For this purpose, the lower surface of the first substrate 110 may be etched to a depth of approximately 50 μm.

The first fluid that flows in a length direction of the filter 100 reaches the filter unit 132. At this point, materials of the first fluid that have a size smaller than the width W of the opening 133 may pass through the opening 133 and may flow down to the second flow channel 152. For example, the flow direction of the first fluid that flows in the first flow channel 116 may be perpendicular to the flow direction of the first fluid that flows down to the second flow channel 152 from the filter unit 132. The flow direction of the first fluid that flows in the first flow channel 116 and the flow direction of the first fluid that flows in the second flow channel 152 may be parallel to each other. However, the target material having a diameter greater than the width W of the opening 133 is stopped at the filter unit 132. For example, when the width W of the opening 133 is 10 μm, red blood cells that have a flat disc shape having a diameter of approximately 7˜8 μm and a thickness of approximately 1˜2 μm may pass through the filter unit 132, that is, the opening 133. However, since the CTCs have a diameter of approximately 20 μm, which is greater than the width W of the opening 133, the CTCs may not pass through the opening 133, and thus, may be captured by the filter unit 132.

The first fluid that passes through the filter unit 132 may have different velocities according to location within the filter unit 132. More specifically, the velocity of the first fluid is temporarily reduced at a region of the filter unit 132 that is close to the inlet 112 by the second substrate 130. The velocity of the first fluid increases as it moves towards the central region of the filter unit 132, that is, the velocity is rapidly increased due to the opening 133. The first fluid maintains a constant velocity in the central region of the filter unit 132, that is, in the central region of the opening 133, and then, the velocity is rapidly reduced as it moves towards the outlet 114. Thus, since the target material having a size greater than the width W of the opening 133 may not pass through the filter 100, the target material moves from the inlet 112 towards the outlet 114 on a surface of the filter unit 132. Also, since the velocity of the first fluid is reduced at a region close to the outlet 114 of the filter unit 132, the target material is captured in a region of the filter unit 132 that is close to the outlet 114.

The length L of the opening 133 is large compared to the diameter of the target material. Thus, although a portion of the filter unit 132 may be clogged by the target material, the opening 133 has enough space to pass the first fluid. Accordingly, the filter unit 132 is not blocked. In a region where the target material is captured, the velocity of the first fluid and fluid pressure are low, and thus, the captured target material may not be damaged by the velocity and fluid pressure. Because most of the first fluid passes the filter unit 132 at a first region 133a, the continuously entering first fluid may not collide with the captured target material in a second region 133b. Thus, the damage or deformation of the target material may be prevented.

The filter 100 enables the convenience observation of the captured target material. Whether the target material is captured or not and the amount of captured target material may be determined by observing the filter unit 132 through a microscope along an edge of the filter unit 132 that is formed as a straight line. FIG. 5 is an image of the target material captured in a region of the filter unit 132. FIG. 5 shows that the target material is captured at an edge region of the filter unit 132.

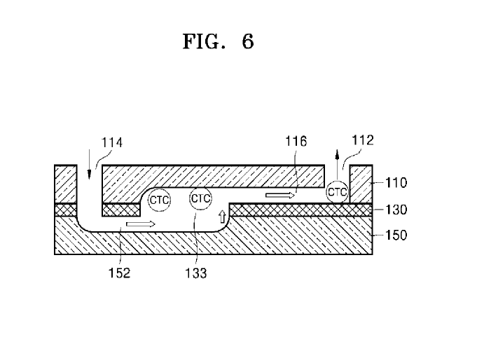

Next, a method of re-collecting the captured target material is described. FIG. 6 is a cross-sectional view for explaining a method of re-collecting the target material captured in the filter 100 of FIG. 1. As depicted in FIG. 4, as the first fluid flows from the inlet 112 towards the outlet 114, the target material included in the first fluid is captured on the filter unit 132 of the filter 100. In order to re-collect the target material captured on the filter unit 132, a re-collect fluid, that is, the second fluid, is reverse-flowed (flowed in a the opposite direction as the first fluid) from the outlet 114 towards the inlet 112. The second fluid may be a material that may re-collect the target material in an intact state. For example, the second fluid may be water, a solution for peripheral blood smear (PBS), or a cell culture medium.

More specifically, the second fluid flows into the filter 100 through the outlet 114, then along the second flow channel 152, the filter unit 132, and the first flow channel 116, and is then discharged through the inlet 112. When the second fluid reversely flows from the second flow channel 152 to the first flow channel 116 through the filter unit 132, the second fluid carries the target material captured on the filter unit 132, and is then discharged through the inlet 112. At this time, the velocity or pressure of the second fluid should be at a level that may carry the target material. Afterwards, the second fluid discharged through the inlet 112 is collected and the target material is extracted from the second fluid. For example, the target material may be cultured by mixing a cell culture medium in the second fluid, or a specific component, for example, hexane, may be extracted from the target material by adding a cell lysis solution to the second fluid.

Non-target material may also be captured on the filter unit 132. At this point, when the second fluid reversely flows from the second flow channel 152 towards the first flow channel 116 through the filter unit 132, the second fluid may have a velocity or pressure that may not carry the non-target material while carrying the target material. Generally, when the target material is captured on the filter unit 132, non-target materials that are smaller than the target material may also be captured on the filter unit 132 or the opening 133 in the filter unit 132 since the non-target materials could not pass through the filter unit 132. The non-target materials are generally captured in the central region of the filter unit 132 since the non-target materials are smaller than the target material.

When the second fluid reversely flows through the filter unit 132, the velocity of the second fluid is reduced from a region of the filter unit 132 that is close to the outlet 114 to a region of the filter unit 132 that is far from the filter unit 132. For example, the velocity of the reverse flow of the second fluid may be maximum at a region where the second fluid initially passes the filter unit 132, that is, a region of the opening 133 that is closest to the outlet 114, and may be minimum at a region where the second fluid finally passes the filter unit 132, that is, a region of the opening 133 that is closest to the inlet 112. This is because the velocity of the second fluid is opposite to the velocity of the first fluid when the first fluid passes through the filter unit 132. Accordingly, the second fluid may carry the target material but may not carry the non-target materials. Also, in order to efficiently re-collect the target material, the velocity of the second fluid may be controlled to carry the target material but not carry the non-target materials.

Afterwards, the second fluid that includes the target material flows through the first flow channel 116 and is discharged through the inlet 112. Since the first and second flow channels 116 and 152 are disposed parallel to each other with different depths, the second fluid may flow in the same direction in the first and second flow channels 116 and 152. Also, since the filter unit 132 is disposed between the first and second flow channels 116 and 152 and is perpendicularly disposed with respect to the flow direction of the fluid in the first and second flow channels 116 and 152, when the second fluid passes through the filter unit 132, the second fluid reversely flows in a direction perpendicular to the flow direction in the first and second flow channels 116 and 152.

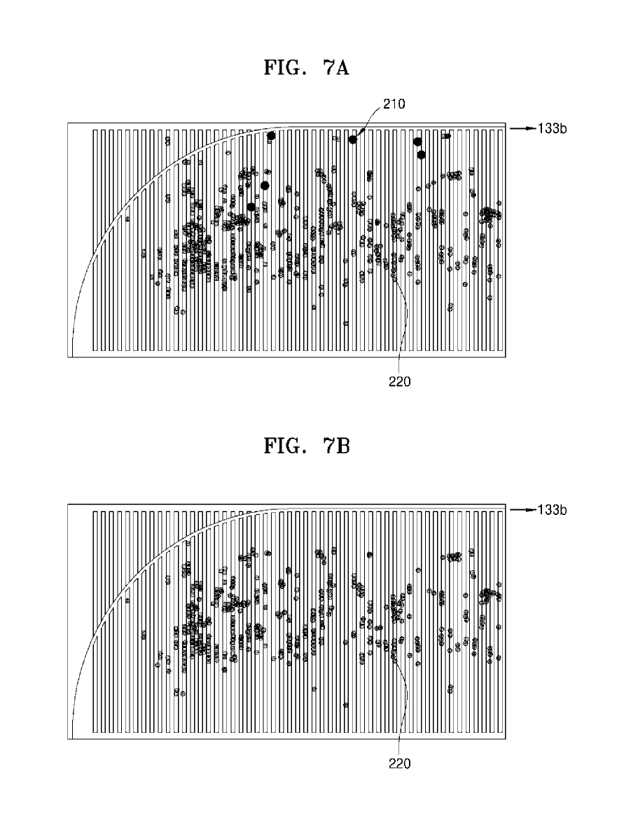

FIG. 7A is an image of a cross-section of the filter 100 in which the target material and non-target materials are captured, and FIG. 7B is an image of the filter 100 from which the target material is re-collected by reversely flowing the second fluid. As depicted in FIG. 7A, non-target materials 220 that are smaller than a target material 210 may also be captured on the filter unit 132. However, the non-target materials 220 are generally captured at a central region of the filter unit 132 when compared to the target materials 210. When the target materials 210 are re-collected by reversely flowing the second fluid, as depicted in FIG. 7B, most of the non-target materials 220 still remain on the filter unit 132 since the velocity of the second fluid in the region where the non-target materials 220 are captured is lower than that in the region where the target materials 210 are captured.

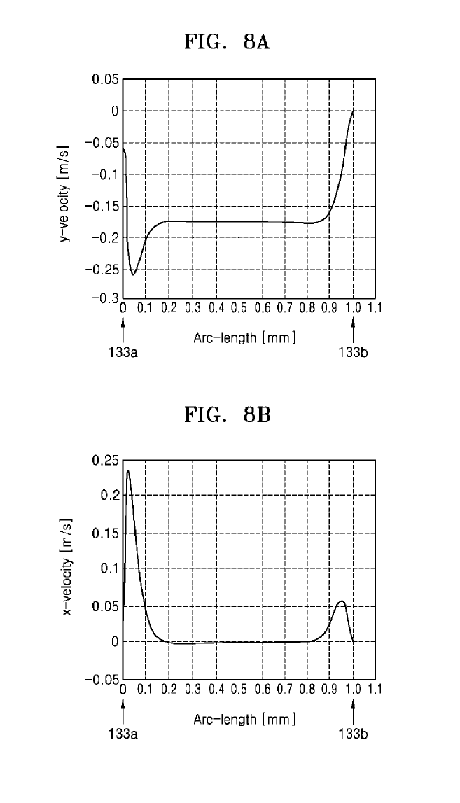

FIG. 8A is a graph showing a result of measuring the velocity of a fluid in a y-axis direction in the filter unit 132, and FIG. 8B is a graph showing a result of measuring the velocity of a fluid in an x-axis direction in filter unit 132. Here, the fluid is the first fluid that flows from the first flow channel 116 towards the second flow channel 152 through the filter unit 132. When a fluid reversely flows, the velocity may be reversed.

In FIGS. 8A and 8B, the x-axis indicates a length L of the opening 133 from the inlet 112 towards the outlet 114, and the y-axis indicates the velocity of the first fluid. For example, an end of the opening 133 in a direction of the inlet 112, that is, a point where the first fluid that enters into the inlet 112 reaches the opening 133, is referred to as a first region 133a, and the other end of the opening 133 facing the first region 133a is referred to as a second region 133b. As shown in FIG. 8A, the velocity of the first fluid is rapidly increased in the first region 133a towards the second flow channel 152, and afterwards, is maintained at a constant level in a central region of the opening 133. The velocity of the first fluid is rapidly reduced as the first fluid moves towards the second region 133b, and becomes zero at the second region 133b. As shown in FIG. 8B, the velocity of the first fluid is rapidly increased as it moves from the first region 133a towards the second region 133b, and afterwards, the velocity is almost zero in the central region of the opening 133. Afterwards, the velocity of the first fluid increases a little near the second region 133b, and then is reduced.

Referring to FIGS. 8A and 8B, the first fluid receives a maximum pressure towards the second flow channel 152 and the second region 133b from the first region 133a of the opening 133, and thus, most of the first fluid passes through the first region 133a of the opening 133. However, the target material having a size greater than the width of the opening 133 may not receive pressure near the second region 133b while moving from the first region 133a towards the second region 133b. Accordingly, the velocity of the target material is reduced in the second region 133b, and thus, the target material is captured near the second region 133b. When the second fluid reversely flows, the velocity of the second fluid may be reversed. When the non-target materials 220 are captured on the filter 100 together with the target material 210, the re-collect rate of the target material 210 by the filter 100 may be said to be high when the re-collect rate of the target material 210 is high and that of the non-target materials 220 is low.

The re-collect rate of the filter 100 according to the current embodiment is measured by a simulation. Assuming that the non-target materials 220 are white blood cells (WBCs), the pressure of the WBCs is approximately 29 nN. Assuming various distribution ranges of the non-target materials 220, that is, noise on a surface of the filter unit 132, the second fluid, such as a PBS solution, having different velocities is reversely flowed through the filter 100.

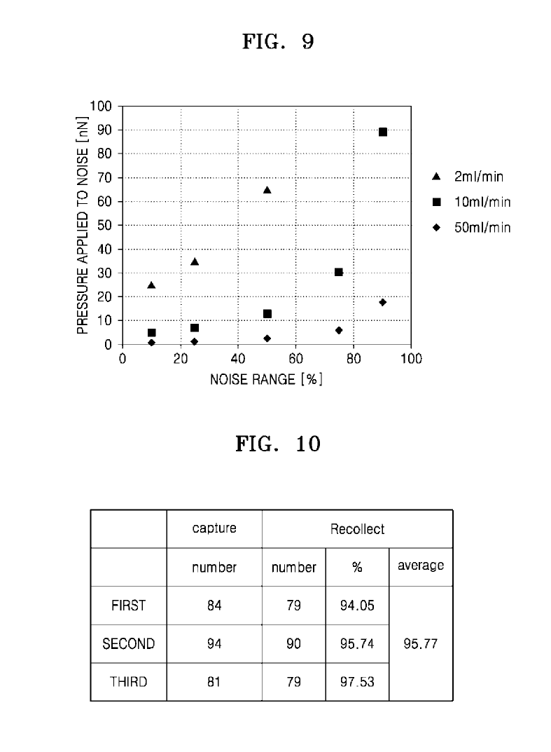

FIG. 9 is a graph showing a simulation result of pressure applied by the second fluid to noise according to a distribution range of the noise. As shown in FIG. 9, as the noise is widely distributed on the filter unit 132, the pressure acting on the noise by the second fluid is increased. When the velocity of the second fluid is approximately 50 ml/min, the pressure applied to the noise is greater than 20 nN, and accordingly, the noise is carried by the second fluid. Here, the velocity denotes a speed when the second fluid passes the filter 100. However, when the velocity of the second fluid is approximately 2 ml/min, although the noise is distributed on the whole filter 100, the pressure applied to the noise may be less than 20 nN. Thus, when the velocity of the second fluid is 2 ml/min, it may be expected that no noise is included in the second fluid that flows in the first flow channel 116. However, if the velocity of the second fluid is too low, the target material may also not be carried. Therefore, when the noise is WBCs, the velocity of the second fluid may be in a range from about 2 ml/min to about 10 ml/min.

When the CTCs as the target material 210 are captured on the filter 100, the PBS solution as a re-collect fluid is flowed into the filter 100 through the outlet 114, and is allowed to reversely flow through the second flow channel 152, the filter unit 132, and the first flow channel 116 at a velocity of 5 ml/min. FIG. 10 is a table summarizing results of measured re-collect rates of a captured target material 210. As depicted in FIG. 10, the re-collect rate is over 90%.

The viability of the re-collected target material 210 was also inspected. The target material 210 is re-collected by varying the velocity of the second fluid that flows into the filter 100. FIG. 11 is a table summarizing the measured viabilities of the re-collected target material 210. The viability of the target material 210 is high regardless of the velocity of the second fluid.

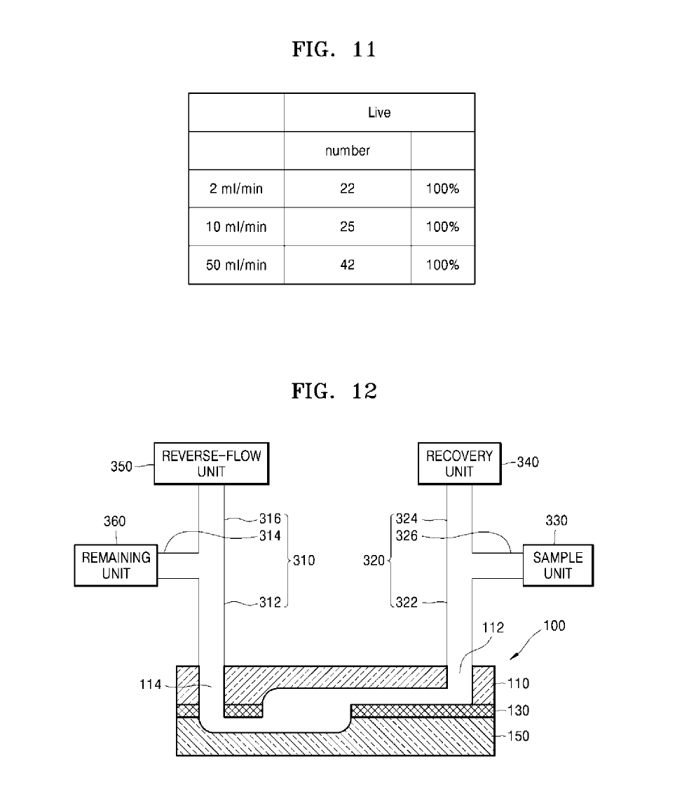

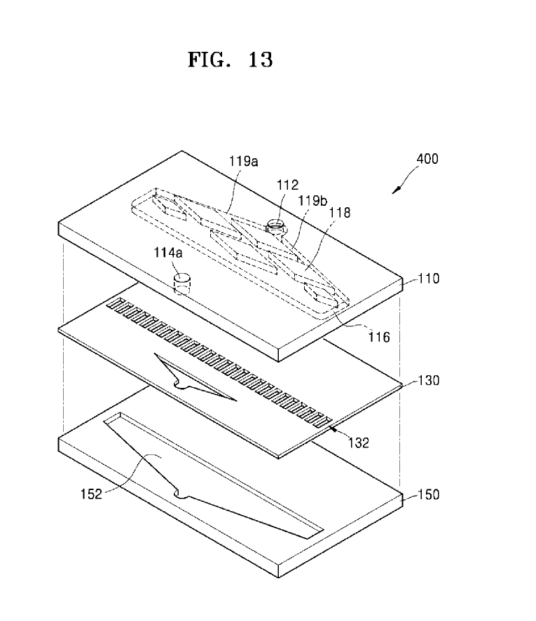

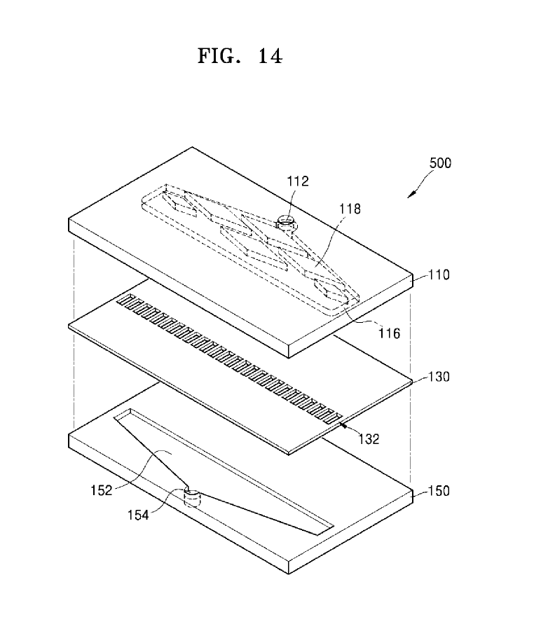

FIG. 12 is a cross-sectional view of the filter 100 that includes first and second port flow channels 310 and 320. Each of the first and second port flow channels 310 and 320 may include three sub-flow channels. For example, an end of a first sub-flow channel 312 in the first port flow channel 310 may be connected to the outlet 114 of the filter 100; an end of a second sub-flow channel 316 in the first port flow channel 310 may be connected to a reverse-flow unit 350 in which the second fluid for re-collecting the target material is stored; and an end of a third sub-flow channel 314 in the first port flow channel 310 may be connected to a remaining unit 360 in which a remaining portion of the first fluid from which the target material is removed is stored. The other edges of the first through third sub-flow channels 312, 316, and 314 are connected to each other. Valves (not shown) that block the sub-flow channels may be formed in the first through third sub-flow channels 312, 316, and 314. In the same manner, an end of a first sub-flow channel 322 in the second port flow channel 320 may be connected to the inlet 112 of the filter 100; an end of a second sub-flow channel 324 in the second port flow channel 320 may be connected to a re-collect unit 340 in which the second fluid that includes the target material is stored; and a third sub-flow channel 326 in the second port flow channel 320 may be connected to a sample unit 330 in which the first fluid that includes the target material is stored. The other edges of the first through third sub-flow channels 322, 324, and 326 are connected to each other. Valves (not shown) that block the sub-flow channels may be formed in the first through third sub-flow channels 322, 324, and 326.

Thus, in order to capture the target material 210, the second port flow channel 320 is controlled to connect the sample unit 330 with the inlet 112, and the first port flow channel 310 is controlled to connect the outlet 114 with the remaining unit 360, and afterwards, the first fluid that includes the target material 210 is allowed to flow into the filter 100 from the sample unit 330 to capture the target material 210 using the filter unit 132 in the filter 100. A remaining portion of the first fluid may flow into the remaining unit 360 through the outlet 114. However, in order to re-collect the target material 210, the second port flow channel 320 is controlled to connect the re-collect unit 340 with the inlet 112 and the first port flow channel 310 is controlled to connect the reverse-flow unit 350 with the outlet 114. Afterwards, the second fluid flows into the filter 100 through the outlet 114 from the reverse-flow unit 350 and may be discharged to the re-collect unit 340 through the inlet 112 after re-collecting the target material 210 captured on the filter unit 132. In FIG. 12, the first and second port flow channels 310 and 320 may be optionally connected to the filter 100, and at least one of the sample unit 330, the re-collect unit 340, the reverse-flow unit 350, and the remaining unit 360 may be directly connected to the filter 100 without connecting through the first and second port flow channels 310 and 320. The filter 100 may further include an element for controlling a fluid that flows through the first flow channel 116.

FIG. 13 is a schematic perspective view of a filter 400 according to another embodiment of the present invention. Referring to FIG. 13, the filter 400 may further include a fluid resistance unit 118 that protrudes in the first flow channel 116. As depicted in FIG. 13, due to the fluid resistance unit 118, a fluid that enters from the inlet 112 may flow towards an edge of the first flow channel 116 through minute narrow channels 119a and 119b that are formed between the fluid resistance unit 118 and an inner wall of the first flow channel 116. Afterwards, the fluid may flow towards a central region of the first flow channel 116 from the edge of the first flow channel 116. The fluid resistance unit 118 may control the velocity and the distribution of stream lines of the fluid that flows in through the inlet 112. For example, the fluid resistance unit 118 may prevent the fluid that flows in through the inlet 112 from directly flowing into the first flow channel 116, and thus, may reduce the velocity of the fluid and may maintain the velocity of the fluid in a constant range. Also, the fluid resistance unit 118 may uniformly distribute the stream lines of the fluid in the first flow channel 116, and may make lengths of the stream lines to be similar to each other. Accordingly, the fluid may uniformly flow along the first flow channel 116 due to the fluid resistance unit 118, and the fluid resistance unit 118 may prevent concentration of the fluid in a specific region of the filter unit 132.

As depicted in FIG. 13, the fluid resistance unit 118 may have a diamond shape. However, the present invention is not limited thereto, and the shape of the fluid resistance unit 118 may have, for example, a polygonal shape, such as a triangular shape or a rectangular shape, a circular shape, an oval shape, a fan shape, a stream line shape, or a combination of these shapes. In FIG. 13, the fluid resistance unit 118 is disposed in the first flow channel 116 to control the flow of the fluid in the first flow channel 116. However, the present invention is not limited thereto, and the fluid resistance unit 118 may also be disposed in the second flow channel 152.

Also, in FIGS. 1 and 13, the inlet 112 and the outlet 114 are formed together in the first substrate 110, but this is but one example configuration. The inlet 112 and the outlet 114 may be formed on different substrates. FIG. 14 is a schematic perspective view of a filter 500 according to another embodiment of the present invention. As depicted in FIG. 14, the inlet 112 may be formed to be connected to the first flow channel 116 passing through the first substrate 110, and the outlet 114 may be formed to be connected to the second flow channel 152 passing through the third substrate 150.

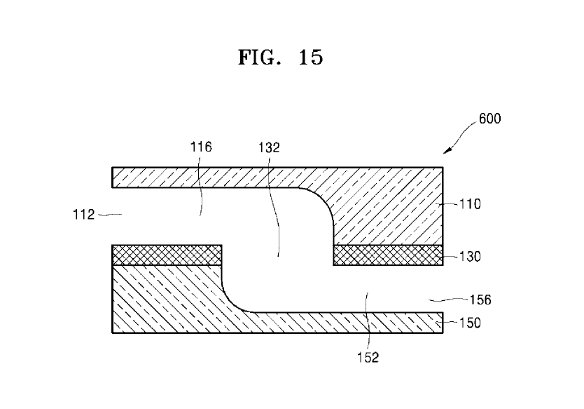

FIG. 15 is a cross-sectional view of a filter 600 according to another embodiment of the present invention. As depicted in FIG. 15, the inlet 112 and the outlet 114 respectively may be formed in the first substrate 110 and the third substrate 150. Also, one of the inlet 112 and the outlet 114 may be formed in a side of the substrate and the other one may be formed through the substrate.

Exemplary embodiments of a filter for capturing a target material and methods of capturing and re-collecting the target material have been particularly described and shown in the accompanying drawings. However, it should be understood that the exemplary embodiments described therein should be considered in a descriptive sense only and not for purposes of limitation. Also, various changes in form and details may be made by those of ordinary skill in the art without departing from the spirit and scope of the invention.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of re-collecting a target material using a filter, the method comprising flowing a first fluid comprising a target material from a first flow channel through a filter unit and into a second flow channel so that the target material is captured in the filter unit, and reverse-flowing a second fluid from the second flow channel through the filter unit and into the first flow channel, whereupon the target material is re-collected from the filter unit in the second fluid; wherein the filter comprises:
the first flow channel;
the second flow channel disposed above the first flow channel and at least partially overlaps with the first flow channel;
and the filter unit that is disposed between the first flow channel and the second flow channel in a region where the first flow channel overlaps with the second flow channel.

2. The method of claim 1, further comprising discharging the first fluid from the second flow channel before flowing the second fluid through the filter.

3. The method of claim 2, further comprising discharging the second flow fluid from the first flow channel, and extracting the target material from the discharged second fluid.

4. The method of claim 1, wherein non-target materials are also captured on the filter unit, and the second fluid in the second flow channel carries only the target material.

5. The method of claim 1, wherein the velocity of the reverse flow of the first fluid is different in different regions of the filter.

6. The method of claim 5, wherein the maximum velocity of the reverse flow of the second fluid is at a region of the filter unit where the first fluid initially passes through the filter unit.

7. The method of claim 1, wherein the target material is captured at an edge region of the filter unit.

8. The method of claim 1, wherein the first fluid flows in the same direction in the first and second flow channels.

9. The method of claim 1, wherein the first fluid passes through the filter unit in a direction perpendicular to the flow direction in the first flow channel.

10. The method of claim 1, wherein the first fluid comprises at least one of water and peripheral blood smear (PBS).

11. The method of claim 1, wherein the target material is captured on the filter unit when the first fluid containing the target material passes through the filter unit.

12. The method of claim 1, wherein the filter unit comprises at least one opening, and a diameter of the target material is greater than a width of the opening and less than a length of the opening.

13. The method of claim 12, wherein the at least one opening has a polygonal shape, a circular shape, or an oval shape.

14. The method of claim 12, wherein the filter unit comprises a plurality of openings arranged in a one-dimensional array or a two-dimensional array.

15. The method of claim 1, wherein the filter comprises
a first substrate including the first flow channel;
a second substrate including the filter unit;
and a third substrate including the second flow channel,
wherein the second substrate separates the first substrate from the third substrate.

16. The method of claim 15, wherein the filter further comprises an inlet in the first substrate that contacts the first flow channel, and the second fluid is discharged through the inlet after reverse-flow through the filter.

17. A method of re-collecting a target material from a filter that comprises a filter unit in which the target material is captured, the method comprising flowing a first fluid containing a target material through the filter, whereupon the target material is captured on the filter unit, and reverse-flowing a second fluid through the filter unit so that the target material is removed from the filter unit and contained in the second fluid.

18. The method of claim 17, wherein the velocity of a reverse flow of the second fluid varies within the filter unit when the second fluid passes through the filter unit.

19. The method of claim 17, wherein the filter unit also captures non-target materials from the first fluid, and the second fluid contains only the target material.

20. The method of claim 17, wherein the filter unit comprises at least one opening, and a diameter of the target material is greater than a width of the opening and is less than a length of the opening.
